(19) United States
(12) Patent Application Publication
(10) Pub. No.: US 2015/0205487 A1
(43) Pub. Date: Jul. 23, 2015

(54) ELECTRONIC DEVICE AND UNLOCK METHOD THEREOF

(71) Applicant: CHIUN MAI COMMUNICATION SYSTEMS, INC., New Taipei (TW)

(72) Inventor: HAISO-MING LIN, New Taipei (TW)

(21) Appl. No.: 14/598,460

(22) Filed: Jan. 16, 2015

(30) Foreign Application Priority Data
Jan. 22, 2014 (CN) 201410030121.0

(51) Int. Cl. G06F 3/0481; G06F 3/0484; G06F 3/0482

(52) U.S. Cl. CPC G06F 3/04817; G06F 3/0482; G06F 3/04842

(57) ABSTRACT

An electronic device having a processor, a lockable and unlockable display, and a storage device is disclosed. A plurality of function icons included in an unlock image are imaged in a locked status and shown on the display. Each of the function icons corresponds to a device function. The processor renders at the display the unlock image, detects a continuous contact at the unlock image, and highlights one of the function icons in response to the continuous contact. Then, the processor toggles, in response to the continuous contact, the highlighting of icons. When the continuous contact is removed, the processor selects the currently highlighted icon and unlocks the display to perform one of the device functions corresponding to the selected function icon.

### CROSS-REFERENCE TO RELATED APPLICATIONS

This application claims priority to Chinese Patent Application No. 201410030121.0 filed on Jan. 22, 2014, the contents of which are incorporated by reference herein.

### FIELD

The subject matter herein generally relates to electronic device security.

### BACKGROUND

Touch screens are popular for use as displays and as user input devices on portable devices, such as mobile telephones, tablets and personal digital assistants (PDAs). One problem associated with using touch screens is the activation or deactivation of functions due to unintentional contact with the touch screen.

### BRIEF DESCRIPTION OF THE DRAWINGS

Implementations of the present technology will now be described, by way of example only, with reference to the attached figures.

FIG. 1 is a block diagram of one embodiment of an electronic device including an unlock system.

FIG. 2 illustrates a flowchart of one embodiment of an unlock method for the electronic device of FIG. 1.

FIG. 3 illustrates a flowchart of one embodiment of an unlock method for the electronic device of FIG. 1.

FIG. 4 is a diagram of one embodiment of an unlock image shown by a display of the electronic device of FIG. 1.

FIG. 5 is a diagram of another embodiment of an unlock image shown by a display of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts have been exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

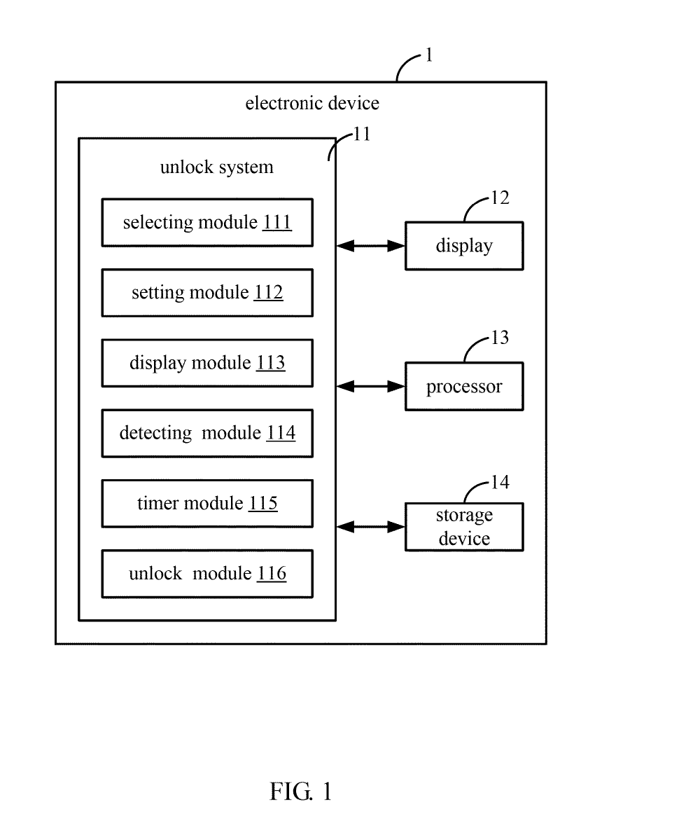

FIG. 1 illustrates an embodiment of an electronic device 1 including an unlock system 11. In the embodiment, the electronic device 1 can include a display 12, a processor 13, and a storage device 14. The storage device 14 can store a plurality of instructions. When the plurality of instructions are executed by the processor 13, the processor 13 can render an unlock image at the display 12. The unlock image includes the plurality of function icons, and each of the plurality of function icons corresponds to a device function. The processor 13 detects, at the display 12, a continuous contact at the unlock image, and highlights one of the plurality of function icons in response to the continuous contact. The processor 13 toggles the highlighting of the icon in response to the continuous contact, and selects for activation the currently highlighted icon when the continuous contact is removed. Then, the processor 13 unlocks the display 12 to perform the device function or functions corresponding to the selected function icon.

When the user tries to unlock the display 12, the user can activate the display 12 in the locked status by an operation, such as by pressing a button. Then, the processor 13 can display the unlock image on the display 12. In one embodiment, the unlock image can be shown at a fixed location of the display 12. In another embodiment, the unlock image can be shown at a random location of the display 12, the location of the unlock image being changeable. In one embodiment, the size of the unlock image can be changed. In another embodiment, the shape of the unlock image can also be changed.

When the processor 13 toggles the highlighting from one function icon to another, the processor 13 can determine a period of time during which the continuous contact is detected to be continuous. Since each of the function icons can correspond to a time threshold, the processor 13 can toggle the highlighting of the icons from a first one of the function icons to a next one of the function icons if the period of continuous contact is longer than the time threshold corresponding to the first one of the function icons.

The unlock image can be set by users or predefined by default. When setting the unlock image, the users can select one or more function icons from a function pool, and add the one or more function icons from the function pool into the unlock image. In one embodiment, the positions of the one or more function icons in the unlock image can be arranged by the users. Then, the users can set a time threshold for each of the one or more function icons. In one embodiment, each of the one or more time thresholds can be different. In another embodiment, each of the one or more time thresholds can be the same.

In one embodiment, when the user takes no action within a certain period after an initial function is activated, the processor 13 can relock the display 14. In one embodiment, when the user tries to quit an initial function by an operation, such as by pressing a button, the processor 13 can relock the display 14.

The display 12 can show the unlock image and receive a finger contact. Thus, the display 12 can be a touch screen. The touch screen can comprise a display device using liquid crystal display (LCD) technology, or light emitting polymer display (LPD) technology, although other display technologies can be used in other embodiments. The touch screen and the touch screen controller can detect contact using any of a plurality of touch sensitivity technologies, including, but not being limited to, capacitive, resistive, infrared, and surface acoustic wave technologies, as well as other proximity sensor arrays or other elements for determining one or more points of contact with the touch screen.

The storage device 14 can be a non-volatile computer readable storage medium that can be electrically erased and reprogrammed, such as read-only memory (ROM), random-access memory (RAM), erasable programmable ROM (EPROM), electrically EPROM (EEPROM), hard disk, solid state drive, or other form of electronic, electromagnetic, or optical recording medium. In one embodiment, the storage device 14 can include interfaces that can access the aforementioned computer readable storage medium to enable the electronic device 1 to connect and access such computer readable storage medium. In one embodiment, the storage device 14 can be a smart media card, a secure digital card, or a flash card.

The processor 13 can be a processor, a central processor (CPU), a graphic processor (GPU), a system on chip (SoC), a field-programmable gate array (FPGA), or a controller for executing the program instruction in the storage device 14 which can be static RAM (SRAM), dynamic RAM (DRAM), EPROM, EEPROM, flash memory, or other types of computer memory. The processor 13 can further include an embedded system or an application specific integrated circuit (ASIC) having embedded program instructions.

In one embodiment, the electronic device 1 can be a mobile phone, a tablet, or other electronic device with a touch screen. FIG. 1 illustrates only one example of an electronic device 1, the electronic device in other embodiments can include more or fewer components than illustrated, or have a different configuration of the various components.

In at least one embodiment, the unlock system 11 can include one or more modules, for example, a selecting module 111, a setting module 112, a display module 113, a detecting module 114, a timer module 115, and an unlock module 116. “Module,” as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable medium include CDs, DVDs, BLU-RAY, flash memory, and hard disk drives.

The selecting module 111 can select a plurality of function icons from the function pool and add the function icons into the unlock image. The setting module 112 can set a time threshold for each of the plurality of function icons. The display module 113 can render the unlock image in the display 12. Then, the detecting module 114 can detect a finger contact at a specific location of the unlock image. Further, the unlock module 116 can sequentially highlight each one of the plurality of function icons and the timer module 115 can determine a period of time during which the finger contact at the specific location is detected to be continuous. The unlock module 116 can toggle the highlighting of the function icons between the plurality of function icons in response to the finger contact, select the currently highlighted icon when the finger contact at the specific location is removed, and unlock the display to perform one of the device functions corresponding to the selected function icon.

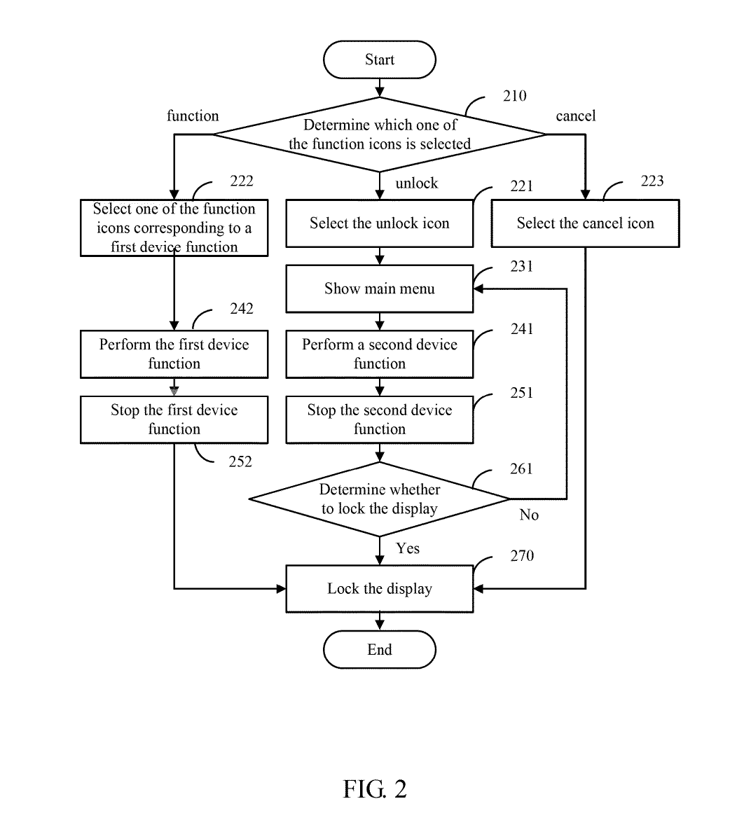

FIG. 2 illustrates a flowchart in accordance with an example embodiment. The example method is provided by way of example, as there are a variety of ways to carry out the method. The method described below can be carried out using the configuration illustrated in FIG. 1, for example, and various elements of these figures are referenced in explaining example method. Each block shown in FIG. 2 represents one or more processes, methods, or subroutines, carried out in the example method. Furthermore, the order of blocks is illustrative only and can change. Additional blocks can be added or fewer blocks can be utilized, without departing from this disclosure. The example method can begin at block 210.

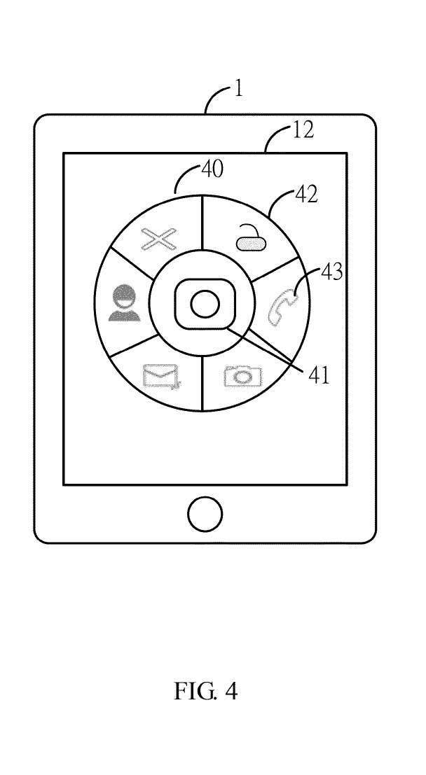

At block 210, the unlock module 116 determines which one of the function icons is selected. Referring to FIG. 4, when the display 12 is in the locked status, the display 12 can show the unlock image 40 including an unlock key 41 and a function list 42 having a plurality of function icons 43. The function icons 43 can include a cancel icon, an unlock icon, and other function icons. Each of the function icons 43 corresponds to a device function. When the user touches the display 12 to contact the unlock key 41 shown in a specific location of the display 12, the unlock module 116 sequentially highlights each one of the function icons 43 and toggles the highlighting of the icons between the function icons 43. The unlock module 116 compares the period of time with a plurality of time thresholds. If the period of time is longer than a first one of the time thresholds, the unlock module 116 will toggle the highlighting from a first one of the function icons corresponding to the first one of the time thresholds to a next one of the function icons. When the user's touch is removed from the unlock key 41, the unlock module 116 can select the currently highlighted icon. If the currently highlighted icon is the unlock icon, the unlock module 116 activates the function of the unlock icon and the procedure goes to block 221. If the currently highlighted icon is one of the function icons which correspond to a first device function, the unlock module 116 activates a first device function corresponding to the one of the function icons, and the procedure goes to block 222. If the currently highlighted icon is the cancel icon, the unlock module 116 activates the function of the cancel icon and the procedure goes to block 223.

At block 221, the unlock module 116 selects the unlock icon.

At block 231, the unlock module 116 unlocks the display 12. Then, the display 12 shows the main menu for the user to select one of the device functions.

At block 241, when the user selects the one of the function icons corresponding to a second device function in the main menu, the processor 13 will perform the second device function for the user.

At block 251, the user stops the second device function. In one embodiment, the user can return to the main menu to stop the second device function. In another embodiment, the user can directly toggle to another device function to stop the second device function.

At block 261, the processor 13 determines whether the user is trying to lock the display 12 or not. In one embodiment, if the user tries to lock the display 12, the unlock module 116 will lock the display and the procedure goes to block 270. Until the user tries to lock the display 12, the procedure remains in block 231.

At block 222, the unlock module 116 selects the one of the function icons corresponding to the first device function.

At block 242, the unlock module 116 unlocks the display 12. Then, the unlock module 116 performs the first device function for the user.

At block 252, when the user stops the first device function, the unlock module 116 will directly relock the display 12 and the procedure goes to block 270.

At block 223, the unlock module 116 selects the cancel icon. Then, the display 223 is not unlocked by the unlock module 116 and the procedure goes to block 270.

At block 270, when the user tries to lock the display 14 at block 261, or stops the first device function at block 252, or when the unlock module 116 selects the cancel icon, the unlock module 116 will lock the display 12.

In one embodiment, when the user tries to directly perform a device function of the electronic device 1 in the locked status, the user can select one of the function icons to unlock the display 12 through the unlock module 116. If the unlock module 116 selects one of the function icons corresponding to a device function, the unlock module 116 unlocks the display 12 to directly perform the device function without showing the main menu or a previous screen. In addition, the unlock module 116 can directly lock the display 12 again when the processor 13 stops the device function. If the unlock module 116 selects the unlock icon, the unlock module 116 can unlock the display 12 to show the main menu or the previous screen and then the display 12 can be locked again, based on the user's operation. If the unlock module 116 selects the cancel icon, the unlock module 116 does not unlock the display 12.

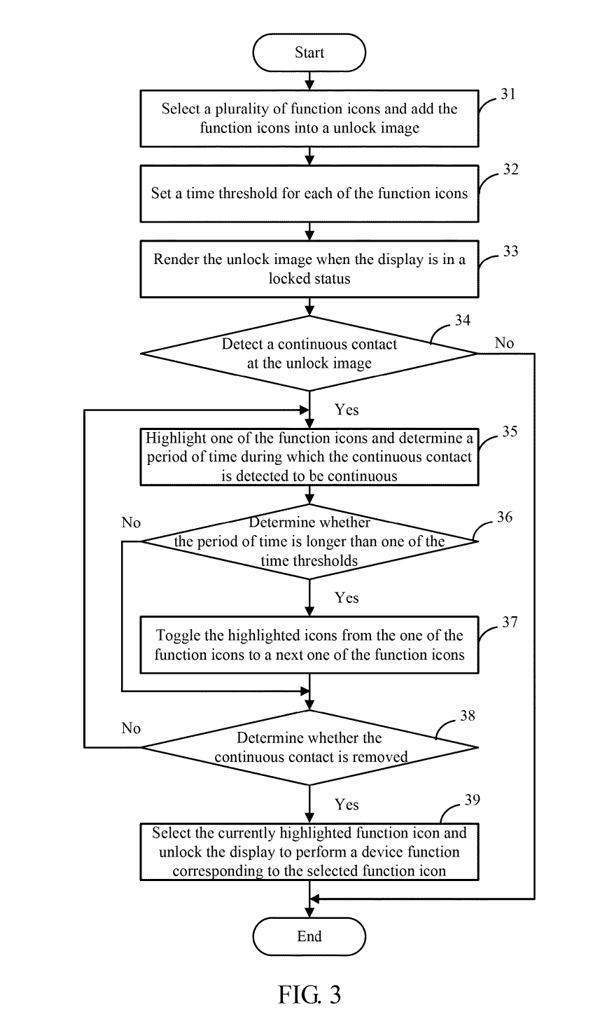

FIG. 3 illustrates a flowchart in accordance with an example embodiment. The example method is provided by way of example, as there are a variety of ways to carry out the method. The method described below can be carried out using the configuration illustrated in FIG. 1, for example, and various elements of these figures are referenced in explaining example method. Each block shown in FIG. 3 represents one or more processes, methods, or subroutines, carried out in the example method. Furthermore, the order of blocks is illustrative only and can change. Additional blocks can be added or fewer blocks can be utilized, without departing from this disclosure. The example method can begin at block 31.

At block 31, the selecting module 111 can select a plurality of function icons 43 and add the function icons 43 into an unlock image 40. In the embodiment, the selecting module 111 can select the function icons 43, such as a message icon, a dial icon, and a camera icon, from a function pool. The function pool can include all of the function icons available in the electronic devices 1.

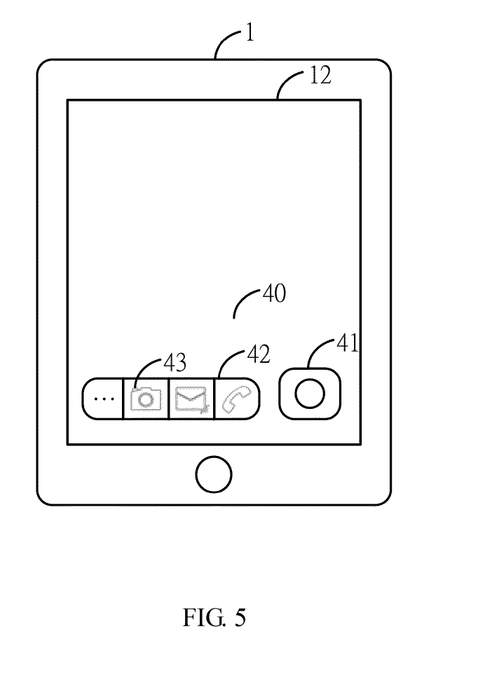

At block 32, the setting module 112 sets a time threshold for each of the function icons 43. In addition, the setting module 112 can arrange the positions of the function icons in a function list 42 of the unlock image 41. The setting module 112 can set the highlight toggling order of the function icons and assign one of the function icons as a first one of the function icons. For example, the highlight toggling order for the function icons in FIG. 4 can be clockwise or counterclockwise, and the highlight toggling order for the function icons in FIG. 5 can be from left to right or from right to left.

In one embodiment, the time threshold of each of the function icons can be the same to generate a single toggling frequency. For example, the unlock module 116 can toggle between the function icons based on the toggling frequency. In one embodiment, the time threshold of each of the function icons can be different.

At block 33, the display module 113 renders the unlock image 40 when the display 12 is in a locked status. When the user tries to unlock the display 12, the user can activate the display 12 in the locked status by an operation, such as by pressing a button. Then, the display module 113 can show the unlock image 40 on the display 12. In one embodiment, the unlock image 40 can be shown at a fixed location of the display 12. In another embodiment, the unlock image 40 can be shown at a random location of the display 12, the location of the unlock image 40 being changeable. In one embodiment, the size and the shape of the unlock image 40 can be changed. In one embodiment, the shape of the unlock key 41 can also be changed. For example, the shape of the unlock key 41 can be a star, a sun, a flower, or a fruit.

In one embodiment, the unlock image 40 includes the unlock key 41 and the function list 42 having the function icons 43. In one embodiment, the function icons 43 can surround the unlock key 41. In another embodiment, the function icons 43 can be listed in the function list 42 near the unlock key 41.

At block 34, the detecting module 114 detects a continuous contact at a specific location of the unlock image 40. In one embodiment, if the detecting module 114 detects a continuous contact at the specific location of the unlock image 40, the procedure goes to block 35. Until the detecting module 114 detects a continuous contact at the specific location of the unlock image 40, the procedure is not activated.

In one embodiment, the location of the unlock key 41 in the unlock image 40 is the specific location of the unlock image 40. Thus, the detecting module 114 detects a continuous contact on the unlock key 41 of the unlock image 40 shown in the display 12.

At block 35, if the detecting module 114 detects a continuous contact at the specific location of the unlock image 40, the unlock module 116 sequentially highlights each one of the function icons and the timer module 115 determines a period of time during which the continuous contact at the specific location of the unlock image 40 is detected to be continuous.

In one embodiment, when the timer module 115 starts to determine the period of time, the unlock module 116 starts from the first one of the function icons set by the setting module 112 to toggle the highlighting of the icons between the function icons.

At block 36, the unlock module 116 determines whether the period of time is longer than one of the time thresholds. In one embodiment, if the unlock module 116 determines that the period of time is longer than one of the time thresholds, the procedure goes to block 37. If the unlock module 116 determines that the period of time is less than one of the time thresholds, the procedure goes to block 38.

At block 37, if the unlock module 116 determines that the period of time is longer than one of the time thresholds, the unlock module 116 toggles the highlighting of the icons from one of the function icons 43 to a next one of the function icons 43. For example, referring to FIG. 4, the first function icon can be set as the dial icon, the second function icon can be set as the camera icon. The toggling direction is clockwise, and each of the time thresholds is set as two seconds. Thus, if the period of time is longer than two seconds, the unlock module 116 will toggle the highlighting of the icons from the dial icon to the camera icon. In addition, if the period of time is longer than another two seconds, the unlock module 116 will toggle the highlighting of the icons from the camera icon to a next icon, such as the message icon. If all of the function icons 43 have been highlighted during the period when the continuous contact at the specific location of the unlock image 40 is detected to be continuous, the unlock module 116 can repeat the sequential highlighting of the function icons.

In one embodiment, when the unlock module 116 toggles the highlighting to highlight a specific function icon, a specific field having the specific function icon can be changed. For example, the shape, the size, the color, or the brightness of the specific field can be changed to further indicate the specific and currently highlighted function icon. In one embodiment, the shape, the size, the color, or the brightness of the specific function icon can be changed.

At block 38, the unlock module 116 determines whether the continuous contact is removed. In one embodiment, if the unlock module 116 determines that the continuous contact at the specific location is removed, the procedure goes to block 39. If the unlock module 116 determines that the continuous contact at the specific location is continuing, the procedure goes to block 35.

At block 39, the unlock module 116 selects the currently highlighted function icon and unlocks the display 12 to perform a device function corresponding to the selected function icon when the continuous contact at the specific location is removed.

In one embodiment, when the continuous contact at the specific location is removed, the unlock module 116 determines which one of the function icons is the currently highlighted icon. For example, the camera icon is currently highlighted when the unlock module 116 stopped toggling due to a removal of contact. Then, the unlock module 116 selects the camera icon and unlocks the display 12 to activate the camera function corresponding to the camera icon. If the unlock icon is currently highlighted when the unlock module 116 stops toggling due to the removal of contact, the unlock module 116 selects the unlock icon and unlocks the display 12 to show the main menu. If the cancel icon is currently highlighted when the unlock module 116 stops toggling due to the removal of contact, the unlock module 116 selects the cancel icon and keeps the display 12 in the locked status.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. An electronic device, comprising:
a display;
a processor; and
a storage device that stores a plurality of instructions, when executed by the processor, causes the processor to:
render at the display an unlock image, wherein the unlock image includes the plurality of function icons, and each of the plurality of function icons corresponds to a device function;
detect, at the display, a continuous contact at the unlock image;
highlight one of the plurality of function icons in response to the continuous contact;
toggle, in response to the continuous contact, the highlighting of the plurality of function icons;
select, the highlighted function icon, when the continuous contact is removed; and
unlock the display to perform one of the device functions corresponding to the selected function icon.

2. The electronic device according to claim 1, wherein the unlock image is shown at a fixed location of the display.

3. The electronic device according to claim 1, wherein the unlock image is shown at a random location of the display.

4. The electronic device according to claim 1, further comprising instructions to:
select the plurality of function icons from a function pool;
add the plurality of function icons into the unlock image; and
set a time threshold for each of the plurality of function icons.

5. The electronic device according to claim 1, further comprising instructions to:
determine a period of time during which the continuous contact at the specific location is detected to be continuous; and
toggle, in response to the continuous contact, the highlighting of the plurality of function icons based on the period of time.

6. The electronic device according to claim 5, further comprising instructions to:
toggle the highlighting of the plurality of function icons from a first one of the function icons to a second one of the function icons when the period of time is longer than a first one of a plurality of time thresholds corresponding to the first one of the function icons.

7. The electronic device according to claim 1, further comprising instructions to:
lock the display after the one of the device functions is stopped.

8. A method for unlocking an electronic device having a display, the method comprising:
rendering at the display an unlock image, wherein the unlock image includes the plurality of function icons, and each of the plurality of function icons corresponds to a device function;
detecting, at the display, a continuous contact at the unlock image;
highlighting one of the plurality of function icons in response to the continuous contact;
toggling, in response to the continuous contact, the highlighting of the plurality of function icons;
selecting, the highlighted icon, when the continuous contact is removed; and
unlocking the display to perform one of the device functions corresponding to the selected function icon.

9. The method according to claim 8, wherein the unlock image is shown at a random location of the display.

10. The method according to claim 8, further comprising:
selecting the plurality of function icons from a function pool;
adding the plurality of function icons into the unlock image; and
setting a time threshold for each of the plurality of function icons.

11. The method according to claim 8, further comprising:
determining a period of time during which the continuous contact is detected to be continuous; and
toggling, in response to the continuous contact, the highlighting of the plurality of function icons based on the period of time.

12. The method according to claim 11, further comprising:
toggling the highlighting of the plurality of function icons from a first one of the function icons to a second one of the function icons when the period of time is longer than a first one of a plurality of time thresholds corresponding to the first one of the function icons.

13. The method according to claim 8, further comprising:
locking the display after the one of the device functions is stopped.
